(19) United States
(12) Patent Application Publication
(10) Pub. No.: US 2010/0235866 A1
(43) Pub. Date: Sep. 16, 2010

(54) ON-DEMAND ENTERTAINMENT CONTENT FOR PASSENGER VEHICLES

(76) Inventor: Sawai S. Jangid, Chennai (IN)

Correspondence Address: SAWAI S. JANGID, c/o SUBRAMANIAN SAHASRANAMAM IYER, APARTMENT 3E,, SEA VERGE APARTMENTS, 385 OCEAN BLVD, LONG BRANCH, NJ, 07740, US

(21) Appl. No.: 12/400,804

(22) Filed: Mar. 10, 2009

(51) Int. Cl. H04N 7/18; H04N 7/173

(52) U.S. Cl. 725/76; 725/87

(57) ABSTRACT

A method and software for providing on-demand entertainment content that includes a server containing stored digital content and configured to transmit their respective stored digital content to the electronic digital display units located proximate to a passenger seat that decodes and displays the video content upon receiving it, and having a user interface that permits a passenger to request the digital movie content stored in the server.

### FIELD OF THE INVENTION

The present invention relates generally to the field of software for entertainment systems, and more particularly, to a method and software for an in-travel entertainment system on a passenger vehicle including aircrafts.

### BACKGROUND OF THE INVENTION

Generally vehicles including aircrafts include several options for entertainment systems during relatively long journeys. The most common entertainment systems may include cabin displays, or individual seatback displays. This includes a display screen attached to the front of the vehicle and viewable by all passengers, or individual seatback displays as in aircrafts. Select movies and entertainment channels are made available on such entertainment systems. Normally the video signals for the various channels are routed to a conventional video and audio distribution system on the vehicle especially the aircraft, and is visible on the display of all the passengers. Random movies or other stored video programming is also selectable by the passenger.

A typical passenger vehicle entertainment system will consist of one or more satellite antennas and electronic equipment in the vehicle, a cable distribution network extending throughout the vehicle, in case of individual viewer panels such as in an aircraft or a bus for individual or different groups of seats. In addition, each passenger seat may include an armrest control and seatback display.

The conventional inventions however are at a loss to solve various issues such as a passenger vehicle being outside of the range of satellites. Further the conventional methods already in use do not address the issue of providing a customized list of content on demand, for viewers to select from on the vehicle. Thus the passenger are not in a position to decide what movies or content they wish to view during the journey, but instead have to be content with the standard fare provided by the channels. The passengers may have a particular movie in mind, but would not be able to view the same as his preference is not sought for. In this situation, the passengers cannot decide what movies to see before actually boarding the vehicle. The passengers may have a particular movie in mind, but there is no guarantee that the vehicle entertainment system has the particular movie in stock. Further the existing entertainment systems may be relatively big with several components and consume valuable space on the vehicle.

Hence a method and software that provides customized on demand entertainment during a journey, especially on flights, and which is more convenient and flexible to provide to the passengers than conventional systems and that can enhance passenger comfort, has been in strong demand. In particular, a method and software that gives priority to passengers' decisions of what movies to view on journey, is highly desirable.

Accordingly, improvements are needed in the existing methods and structures that facilitate in-vehicle entertainment.

The relevant prior art methods, which will deal with entertainment systems for passenger vehicles, are as follows:

U.S. Pat. No. 5,705,860 discloses a vehicle passenger information system, for example an invehicle entertainment system, has a combination of improvements for reducing electromagnetic interference (“EMI”) and electrostatic discharge (“ESD”). A microprocessor based system controller has a system controller chassis with a first conductive EMI shield layer, a low impedance aircraft chassis ground path directly electrically connected to the shield layer and to controller components. Additionally, a display unit has a chassis with a second conductive EMI shield layer enclosing a plurality of PCBs directly electrically connected to the shield layer. The display unit supports are grounded through a plurality of system connectors penetrating the display chassis and a low impedance display unit ground path directly electrically connects the two shield layers. A method of decreasing the EMI and ESD susceptibility of, and the levels of radiated EMI from, a vehicle entertainment system is also provided.

U.S. Pat. No. 5,973,722 describes an in-flight passenger entertainment system has a first digital network for communication among components of a headend system including a data server, media controller, one or more media servers, system interface unit, system manager unit and attendant control panel. The in-flight entertainment system is coupled to an aircraft's existing systems through the system interface unit and the system manager unit. The components of the headend system are all coupled to a network switch for routing data within the first network. The network switch is also coupled to one or more zone bridge units, each of which is coupled to multiple seat electronics units. The zone bridge units and the seat electronics units together form a second digital network. The first digital network is preferably an ATM network with fibre optic cables used to carry the data. The second digital network is preferably an IEEE 1394 serial bus network. The zone bridge units control all communications between the networks, converting all communications into the format required by the respective network. A first audio path for transmitting audio content from the headend system is routed to predetermined seat entertainment units through the network switch and the zone bridge units. A second audio path for transmitting audio from the system interface unit is routed to the seat entertainment units through the zone bridge units.

U.S. Pat. No. 6,266,736 claims as a method to update information including code and data in a non-volatile memory reliably and efficiently to avoid loss of information during the loading process and to minimize aircraft service downtime in an In-Flight Entertainment System (IFES). The non-volatile memory is partitioned into two sections: one section contains the currently valid information and the other is available for loading the new information. A section pointer is used to keep track of the currently valid section and to select the loading section. The new information is loaded to the selected loading section. A validation procedure is performed to determine if the loading is successful. When the loading of the new information is successfully completed, the section pointer is updated to point to the newly loaded section.

U.S. Pat. No. 7,280,825 describes an aircraft in-flight entertainment (IFE) system includes an antenna, an external communications transceiver connected to the antenna for communicating external the aircraft, and a plurality of seat electronic boxes (SEBs) spaced throughout the aircraft for distributing entertainment related data. A distribution network is connected to the SEBs and to the external communications transceiver. An internal communications transceiver is connected to the distribution network for establishing an external communications link with a portable wireless device carried by a passenger internal to the aircraft.

U.S. Pat. No. RE 39,303A claims as a satellite television system that provides live television programming to passengers by integrating direct broadcast satellite services into an inflight aircraft entertainment system. The system has an antenna disposed on the aircraft that is pointed at a plurality of satellites that are part of a direct broadcast satellite system. The antenna is controlled by an antenna controller and antenna interface unit that send control signals and process status signals to steer the antenna. The antenna is steered to lock it onto RF signals transmitted by the satellites. The antenna interface unit downconverts the received encoded RF signals to provide encoded left hand circularly polarized RF signals and right hand circularly polarized RF signals that contain different sets of television channels. The downconverted encoded RF signals are processed by a receiver to provide encoded video and audio signals of different television channels. The receiver does not decode or D/A convert the downconverted signals. The encoded video and audio signals containing the plurality of channels are modulated in a modulator, which also is used as a combiner to modulate signals derived from other video and audio sources. The modulated and encoded video and audio signals are routed to a video and audio distribution system which distributes the encoded video and audio signals to each passenger's seat. Seat electronics circuitry is located at each passenger's seat that contains a demodulator, decoder, digital to analog converters, and an optional tuner. The seat electronics circuitry demodulates, decodes and D/A converts the modulated and encoded video and audio signals into signals that may be viewed and heard by the passenger at that seat.

However the purpose and methodology of all the inventions that are part of prior art do not envisage the unique embodiment of the use of an on-demand entertainment content for passenger vehicles.

The present invention differs from the existent prior art in that it seeks to provide a novel method and software that provides entertainment content for passenger vehicles on the specific demand of the passenger.

Further it will be apparent to those skilled in the art that the objects of this invention have been achieved by providing an on-demand entertainment system which is unique in nature unlike existing entertainment systems for passenger vehicles that are suited only for limited purposes. Various changes may be made in and without departing from the concept of the invention. Further, features of some stages disclosed in this application may be employed with features of other stages. Therefore, the scope of the invention is to be determined by the terminology of the following claims and the legal equivalents thereof.

### SUMMARY OF THE INVENTION

This present invention may be summarized at least in part, with reference to its objects.

The foremost object of this invention is to provide an on-demand entertainment content during a journey which is more convenient and flexible for the vehicle to provide to the passengers

Another object of the present invention is provide an on-demand entertainment content that gives priority to passengers' decisions of what movies to view on the journey.

Another object of the present invention is provide specific and relevant advertisements at the time of commencement and completion of the journey, that will be of interest to the passengers.

Yet another object of the present invention is to solve various secondary issues such as a passenger vehicle being outside of the range of satellites, etc.

A further object of the present invention is to provide an on-demand entertainment content without significantly altering the existing system or creating space limitations.

In accordance with the foregoing, a method and software for providing on-demand entertainment content is provided. In an embodiment of the invention, the system includes a server placed within the passenger vehicle, having stored thereon digital content. The system also includes an electronic digital display unit or units, each being located proximate to a passenger seat for comfortable viewing, and having a user interface that permits a passenger to request the digital movie content stored in the server. The server is configured to transmit their respective stored digital content to the electronic digital display units. Each of the plurality of electronic digital display units decodes and displays the video content upon receiving it.

Additional objects and embodiments of the invention will be set forth in part in the description which follows, and in part will become apparent to those skilled in the art upon examination of the following, or may be learned by practice of the invention. These and other objects and advantages and features of the present invention will be more readily apparent when considered in reference to the following description and when taken in conjunction with the accompanying drawings listed below.

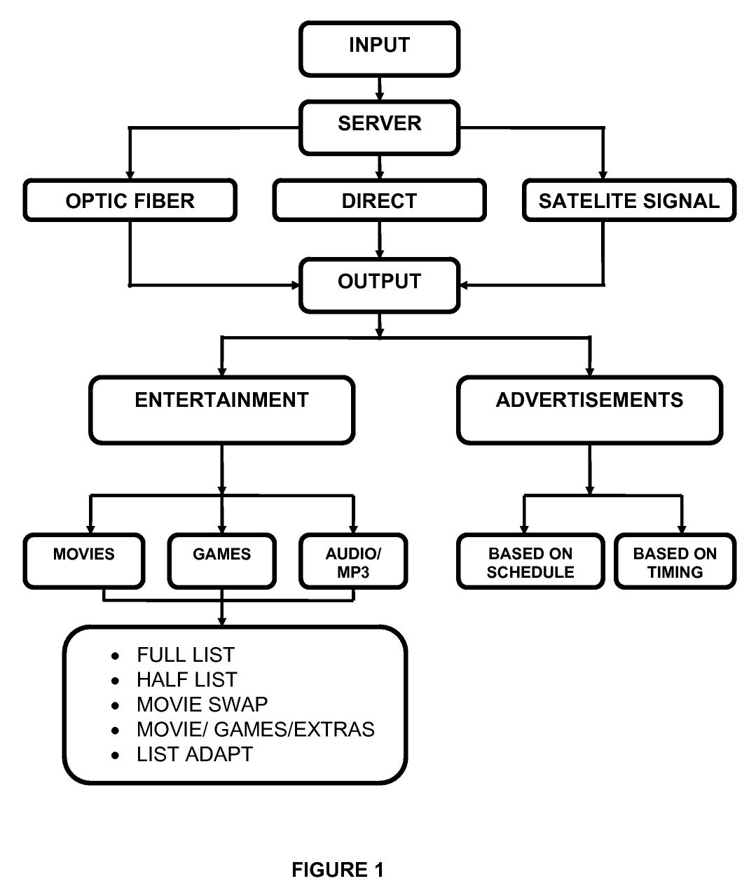

FIG. 1 is a flow chart diagram illustrating the working of the present invention.

### DETAILED DESCRIPTION OF THE INVENTION

The following description is presented to enable any person skilled in the art to make and use the invention, and is provided in the context of particular applications of the invention and their requirements. The present invention can be configured as follows:

The present invention is designed for use in any passenger vehicle.

FIG. 1 illustrates the present method and software for providing on-demand entertainment content. In an embodiment of the invention on the booking of tickets for travel in a passenger vehicle, the passengers are provided with the option of listing the names of the movies the passenger would like to see on the journey. These movie preferences can be stated by the passengers even after the booking of their tickets, and until a particular cut off time before the commencement of the journey. This data is fed into the computer system in response to processor executing one or more sequences of one or more instructions contained in main memory. In alternative embodiments, hard-wired circuitry may be used in place of or in combination with software instructions to implement the invention.

Examples of items that can be stored on the server include but are not limited to movies, advertisements, music and games. In general, the decision of what movies to view is separated from the decision of the order in which the movies are preferred to be viewed. Passengers may specify what movies to view using one or more movie selection criteria separate from deciding the order in which they wish to view the specified movies.

The movie selection criteria may specify particular movie titles that passenger desires to view. The movie selection criteria may also specify an order or priority in which passenger wishes to view the movies. Instead of identifying particular movie titles, the movie selection criteria may specify movie preferences for passenger, e.g., types of movies, directors, actors, or any other movie preferences or attributes. In this situation, provider automatically selects particular titles that best satisfy the movie selection criteria.

In some situations, passenger may desire to increase or decrease the size of passenger's movie list before the cut off time. According to one embodiment, passenger notifies provider, e.g., by telephone, mail, email or by accessing the web site associated with provider, that passenger wishes to change the movie list. The movie list of the passenger is then modified to reflect the changes.

The above data is then transferred to a server. The entertainment data supplied by each passenger is then added to by transferring the requested video program to the said server. Thus the entertainment related data in a server may comprise at least the list of movies provided, and the video program of all or some of the movies on the list. The number of movies to be loaded onto the server is chosen based on various characteristics such as the storage capacity of the server, size of monitor, number of passengers, etc.

The movie may be divided into sections for easy storage on the server. When a passenger selects a particular movie, retrieval of the different sections of the video program of the movie is transparent to the passenger. The entertainment related data on the server may also comprise audio, such as MP3 files.

The server is placed within the passenger vehicle by either transferring the disk into the vehicle or using an optic fiber line—either storage or direct link. The server advantageously provides entertainment related data to the passengers without requiring live transmission of data from satellite signals. The system further includes an electronic digital display unit or units, each being located proximate to a passenger seat for comfortable viewing, and having a user interface that permits a passenger to request the digital movie content stored in the server.

Each passenger seat may further comprise a respective headphone detection circuit connected to at least one passenger processor, and a respective headphone jack may be connected to each headphone detection circuit for receiving headphones. The headphone detection circuit may set a volume of the entertainment related data to a predefined level when removal of the headphones has been detected. In addition, the headphone detection circuit may be used to detect a failure of the headphones.

According to one embodiment, a passenger provides one or more item selection criteria. The item selection criteria indicate the movies that passenger desires to view on the journey. In response to receiving the movie selection criteria from passenger, the server is stored with the said content and configured to transmit their respective stored digital content to the electronic digital display units via a switch including a plurality of outputs, with each output being connected to a respective passenger seat. Each of the plurality of electronic digital display units decodes and displays the video content upon receiving it. The system may further comprise a satellite television receiver connected to the switch for providing TV programming channels to the passenger seats via the plurality of outputs. The above network switch advantageously permits more than one passenger to simultaneously access the same movie.

According to an embodiment, upto a specified number of movies can be stated by passenger and these movies can be provided partly to the passenger by the storage of all contents relating to said movies on the server, thus facilitating a “Half List” option.

According to an embodiment, upto a specified number of movies can be stated by passenger and these movies can be provided simultaneously to passenger by the storage of all contents relating to said movies on the server, thus facilitating a “Full List” option.

Thus, the “Full List” option establishes the size of an inventory of movies that may be maintained by passengers. The specified number of movies may be specific to each passenger or may be common to one or more passengers. If the specified number of movies is three, then up to three movies may be viewed simultaneously by passenger. If all the specified number of movies are viewed to the finish by the passenger, then the specified movie delivery criteria triggers the availability of one or more additional movie for viewing or any games or music related to the said movies, thus facilitating a “Movie Extras” option.

According to another embodiment, a “Movie Swap” option allows passengers who have changed their preferences at the last minute to exchange upto a specified number of movies on their list with any other movie on a random list provided on the server, within a specified period of time, such as within 15 minutes after the commencement of the journey.

According to another embodiment, a “List Adapt” option allows passengers who have changed their preferences at the last minute to substitute their list of movies with the list of any other passenger, within a specified period of time, such as within 15 minutes after the commencement of the journey.

The one or more movie list provided by passenger indicate the particular movies that passenger desires to view. Thus, the movie list defines a passenger-specific order queue that is fulfilled by providing the movie content in the same order of preference in the server.

According to one embodiment, a “Full List” option is used to manage the number of movies that may be simultaneously viewed to passengers. According to this, up to a specified number of movies may be viewed simultaneously to a passenger.

According to one embodiment, the “Movie Extra” option is implemented in combination with the “Half List” option also. In this situation, up to a specified number of total movies stated by the passenger are provided on the server and are simultaneously viewed by passenger. If all the specified number of movies are viewed to the finish by the passenger, then the specified movie delivery criteria triggers the availability of one or more additional movie for viewing or any games or music related to the said movies, thus facilitating a “Movie Extras” option.

According to one embodiment, the server will monitor the data viewed by an individual passenger. The server will further track the number of times a particular data has been viewed.

In some situations, where the passenger is a frequent traveler on the particular passenger vehicle, he may wish to state a standard list of movies during a specified period of travel, maybe a month, instead of providing the list time and again before each journey. According to one embodiment, in this situation, all these movies are provided on the server simultaneously viewed by passenger during all his/her journeys during the specified time period, of maybe a month.

In other situations, where the passenger is a frequent traveler on the particular passenger vehicle, passenger may not use all of its allotted movies during a journey. According to one embodiment, passengers can carry forward the unviewed movies in this list to the next journey during a specified time period, of maybe a month.

According to one embodiment, advertisements are also stored in the server and strategically displayed on the electronic digital display unit based on timing and based on vehicle schedule. Specific advertisements related to the place will be displayed at the time of commence of journey and again at the time of completion of journey.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

It will be apparent to those skilled in the art that the objects of this invention have been achieved by providing the above invention. However various changes may be made in the structure of the invention without departing from the concept of the invention. Therefore, the scope of the invention is to be determined by the terminology of the following claims and the legal equivalents thereof.

What is claimed is:

1. A method and software for providing on-demand entertainment content for passenger vehicles comprising a server placed within the passenger vehicle, an electronic digital display unit or units and a user interface characterized in that, said server having stored thereon digital content and is configured to transmit their respective stored digital content to said electronic digital display units.

2. The method and software as claimed in claim 1 wherein said electronic digital display unit or units are located proximate to a passenger seat.

3. The method and software as claimed in claim 1 wherein said electronic digital display unit or units decodes and displays the video content upon receiving it.

4. The method and software as claimed in claim 1 wherein said passenger seat may comprise a respective headphone detection circuit connected by a respective headphone jack for receiving headphones and said headphone detection circuit is connected to at least one passenger processor, which may set a volume of the entertainment related data to a predefined level when removal of said headphones has been detected.

5. The method and software as claimed in claim 1 wherein passengers, during the booking of tickets for travel in a passenger vehicle and even after the booking of their tickets until a particular cut off time before the commencement of the journey, are provided with the option of listing the names of the movies said passenger would like to view on the journey and passenger on being a frequent traveler on said passenger vehicle, can state a standard list of movies during a specified period of travel, instead of providing the list time and again before each journey.

6. The method and software as claimed in claim 1 wherein said passenger provides one or more item selection criteria that indicate the movies that said passenger desires to view on the journey and may specify what movies to view and the order in which they wish to view the specified movies using one or more movie selection criteria.

7. The method and software as claimed in claim 1 wherein said passenger data is fed into the computer system in response to processor executing one or more sequences of one or more instructions contained in main memory, and hard-wired circuitry may be used in place of or in combination with software instructions to implement.

8. The method and software as claimed in claim 1 wherein said data, which may also comprise audio, including but not limited to MP3 files, and requested video program is then transferred to said server.

9. The method and software as claimed in claim 1 wherein the number of movies to be loaded onto said server is chosen based on the storage capacity of the said server, the size of monitor and on the number of passengers and said server storage includes but are not limited to movies, advertisements, music and games and said movie may be divided into sections for easy storage on said server.

10. The method and software as claimed in claim 1 wherein said server is placed within said passenger vehicle by transferring the disk into the vehicle and by using an optic fiber line and storage and an optic fiber line and direct linking.

11. The method and software as claimed in claim 1 wherein said server is configured to transmit their respective stored digital content to the electronic digital display units, which decodes and displays said video content upon receiving it, via a switch including a plurality of outputs and said output is connected to a respective passenger seat

12. The method and software as claimed in claim 1 wherein the movie selection criteria on said electronic display until connected to said server may specify particular movie titles that passenger desires to view, in an order or priority in which passenger wishes to view the movies, including but not limited to movie genre, directors, actors, or any other movie preferences or attributes and said passenger notifies said provider, e.g., by telephone, mail, email or by accessing the web site associated with provider, that said passenger wishes to modify the movie list.

13. The method and software as claimed in claim 1 wherein the provider automatically selects particular titles that best satisfy said movie selection criteria and retrieval of the different sections of the video program of said movie is transparent to said passenger when a particular movie is selected.

14. The method and software as claimed in claim 1 wherein said data in said server may comprise at least the list of movies provided, and the video program of all or some of the movies on the list.

15. The method and software as claimed in claim 1 wherein a specified number of said movies can be stated by said passenger, which may be specific to each said passenger or may be common to one or more said passengers with some of the movies being provided to said passenger facilitating a “Half List” option, and all of the movies being provided to said passenger facilitating a “Full List” option, by the storage of said movie video content on the server.

16. The method and software as claimed in claim 1 wherein a specified number of said movies if viewed to the finish by said passenger, triggers the availability of one or more or any games or music related to said movies or one or more additional movies for viewing thus facilitating a “Movie Extras” option.

17. The method and software as claimed in claim 1 wherein passengers who have changed their preferences at the last minute can exchange upto a specified number of movies on their list with any other movie on a random list provided on the server thus facilitating a “Movie Swap” option and can substitute their list of movies with the list of any other passenger, thus facilitating a “List Adapt” option, both of which can be exercised within a specified period of time after the commencement of the journey.

18. The method and software as claimed in claim 1 wherein the movie list on said movie selection criteria defines a passenger-specific order queue that is fulfilled by providing said movie content in the same order of preference in said server and said server will monitor the data viewed by said passenger and will track the number of times a particular data has been viewed

19. The method and software as claimed in claim 1 wherein all said movies are provided on said server for view during all journeys during the specified time period and if said passenger does not use all of its allotted movies during a journey, the unviewed movies can be carried forward to the next journey during a specified time period.

20. The method and software as claimed in claim 1 wherein advertisements, stored in said server, are strategically displayed on said electronic digital display unit based on timing and vehicle schedule and said advertisements related to the place will be displayed at the time of commence of journey and again at the time of completion of journey.
